(19) United States
(12) Patent Application Publication
(10) Pub. No.: US 2003/0023974 A1
(43) Pub. Date: Jan. 30, 2003

(54) Method and apparatus to track objects in sports programs and select an appropriate camera view

(75) Inventors: Serhan Dagtas, Croton on Hudson, NY (US); John Zimmerman, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/912,684

(22) Filed: Jul. 25, 2001

(51) Int. Cl. G06F 3/00

(52) U.S. Cl. 725/47

(57) ABSTRACT

The present invention provides techniques for tracking objects in sports programs and for selecting an appropriate camera view. Generally, in response to preferences selected by a user, a particular object in a sporting event is tracked. Not only is the object tracked, but statistical data about the object is compiled and may be displayed, depending on user preferences. Additionally, a user can select particular cameras to view or can select certain portions of the playing field to view.

### FIELD OF THE INVENTION

The present invention relates to multimedia, and more particularly, to a method and apparatus to track objects in sports programs and select an appropriate camera view.

### BACKGROUND OF THE INVENTION

In most live television programs, including sports games, multiple cameras are used to record an event and one of the cameras is manually selected by the program editor to reflect the “most interesting” view. The “most interesting view” is, however, a subjective matter and may vary from person to person.

There is one system that has multiple feeds and that allows a user to select one of the feeds. Each feed is still controlled by a program editor, but this system does allow a user some control over how a program is watched. However, the amount of control given to a user is small. For instance, a user might have a favorite player and would like this player shown at all times. With current systems, this is not possible.

There is even less control for a user over the types of sports statistics shown. Most sports statistics are collected by a person who actually views the game and enters statistics into a computer or onto paper. The user sees only the statistics that are collected by a statistician and that the network deems to be most important.

A need therefore exists for techniques that provide a user with more control over what is watched in a program and that provide more statistical information than currently provided.

### SUMMARY OF THE INVENTION

The present invention provides techniques for tracking objects in sports programs and for selecting an appropriate camera view. Generally, in response to preferences selected by a user, a particular object in a sporting event is tracked. In addition, statistical data about the object is compiled and may be displayed, according to user preferences. Additionally, a user can select particular cameras to view or can select certain portions of the playing field to view.

A more complete understanding of the present invention, as well as further features and advantages of the present invention, will be obtained by reference to the following detailed description and drawings.

### BRIEF DESCRIPTION OF THE DRAWINGS

FIG. 1 is a flowchart of a method for tracking objects in sports programs and selecting an appropriate camera view, in accordance with a preferred embodiment of the invention;

FIG. 2 is a block diagram of a transmitting section of an apparatus for tracking objects in sports programs and selecting an appropriate camera view, in accordance with a preferred embodiment of the invention;

FIG. 3 is a block diagram of a receiving section of an apparatus for tracking objects in sports programs and selecting an appropriate camera view, in accordance with a preferred embodiment of the invention; and

FIG. 4 is a block diagram of a system suitable for implementing all or a portion of the present invention.

### DETAILED DESCRIPTION

The present invention allows an object in a program, particularly a sports program, to be tracked. Although not limited to sports programs, the present invention is particularly suitable for sports programs, as these are live, contain multiple cameras, and have a significant amount of statistical information. The object to be tracked is selected by a user.

Because a particular object is being tracked, additional statistics about the object can be gathered. For instance, if the object is a player, statistics such as the amount of time on the field, distance ran, balls hit, and time spent running can be determined.

In one embodiment, a transmitter collects this information from the available camera views. The transmitter packages tracking information and statistics and sends this data to users, along with the different camera views. A receiver, controlled by a user, then implements the preferences of the user by selecting camera views and statistics for display. It is also possible for the receiver to determine statistics and tracking information. However, this could require a more advanced receiver, and, since there will generally be many such receivers, this could be more expensive than a single advanced transmitter and relatively simple receivers.

Additionally, a user is allowed to select a single camera view or a portion of the playing field. These selections, along with the previously discussed selections, allow a user almost complete control over how a sporting event is displayed.

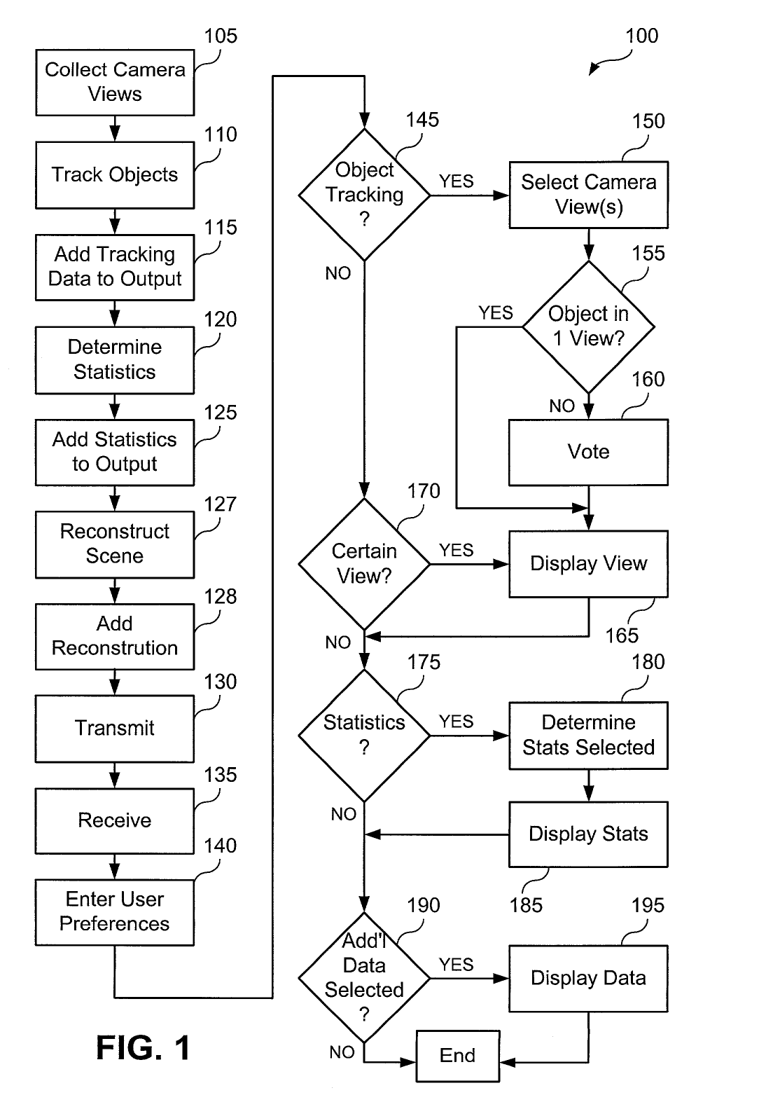

Referring now to FIG. 1, a method 100 is shown for tracking objects in sports programs (and other content) and selecting an appropriate camera view, in accordance with a preferred embodiment of the invention. Method 100 is used to collect camera views, to track objects and compile statistics about those objects, and to select, based on user preferences, camera views or appropriate statistics or both for display.

Method 100 assumes that a transmitter tracks objects and collects statistical data about the objects. A receiver then determines which camera view and which statistics should be displayed. As discussed above, these assumptions can be changed.

Method 100 begins in step 105, when all camera views are collected. Method 100 simply collects all possible camera views and uses these views when tracking objects and determining statistics. Optionally, there could be one camera that facilitates this process by permanently capturing the entire playing area.

In step 110, each object of potential interest is tracked. In the exemplary sports program embodiment, the objects could be the ball, puck, other sporting goods, players, or referees. Basically, anything that is within a camera view can be tracked, including stationary objects. The tracking that occurs in step 110 may be performed by any mechanisms known to those skilled in the art. For instance, face, number, or object recognition may be used. Such techniques are well known to those skilled in the art. For instance, face tracking is described in Comaniciu et al., “Robust detection and tracking of human faces with an active camera,” Third IEEE Int'l Workshop on Visual Surveillance, 11-18 (2000); object tracking is described in Park et. al, “Fast object tracking in digital video,” IEEE Transactions on Consumer Electronics, 785-790 (2000).

A relatively easy technique, useful for tracking objects, is to place a Radio Frequency Tag (RF Tag) on the object. RF tags are now quite small, and can be inconspicuously placed on a uniform or even inside a ball. As is known in the art, RF tags create a small amount of power from RF waves that are transmitted to and received by them. An RF tag uses this power to transmit its own RF waves. By having each RF tag transmit a particular code or potentially at a different frequency, a series of RF receivers can be used to determine where the RF tag is located.

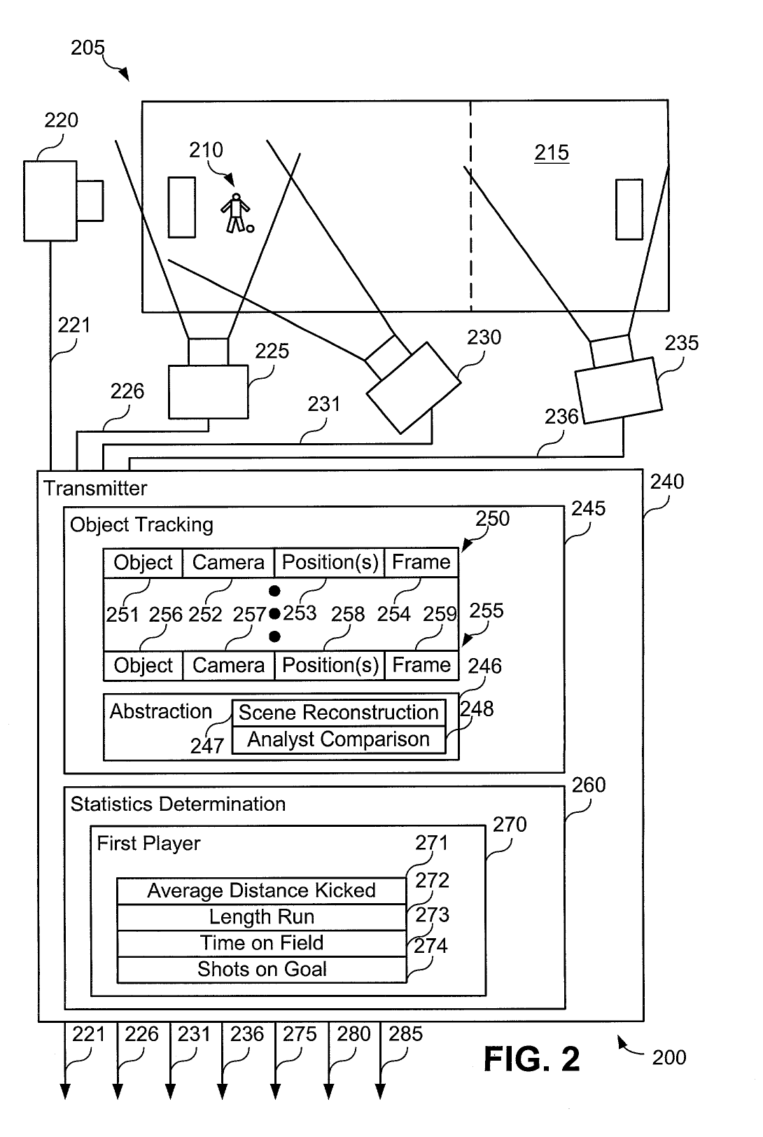

In step 115, the collected tracking data is added to an output that will be transmitted. Exemplary tracking data and output are shown more particularly in FIG. 2. Briefly, it is beneficial to determine which camera views contain an object of interest. Objects are generally listed individually, along with which camera views contain the object and where the object is in a camera view.

In step 120, statistics are determined for each object that was tracked in step 110. Because objects are being tracked, it is relatively easy to collect statistical information about the object. For example, the distance ran by a player can easily be tracked, along with the average speed, fastest speed, time at rest, time on the playing field, shots taken, balls returned, and number of hits.

In step 125, these statistics are added to the output. There are a variety of techniques that can be used to add the statistics to the output. One exemplary technique is shown in FIG. 2. Generally, the statistics are transmitted on an object-by-object basis, which means that statistics are collected for an object and sent separately from the statistics of other objects. However, the statistics can be aggregated so that statistics for a variety of objects are packaged in one location. Any technique for transmitting statistics may be used, as long as the statistics can be correlated to a particular object.

It should be noted that steps 120 and 125 may be used to add additional features to a data stream. For instance, it is possible to track a hockey puck and add a line or spot that is used to better display the puck. This technology is currently available and previously used. Similarly, technology exists for adding “first down” lines on a broadcast view of a field of a football game, and adding “world record” lines on a broadcast view of a track meet or swimming event. If these lines are separated from the broadcast picture and sent as data, a user can then decide whether to turn the lines on or off. Consequently, steps 120 and 125 can add tracking events, such as highlights for a hockey puck or a ball and lines for first downs and records. A user can then choose to activate these tracking events.

In step 127, a scene created by the camera views is reconstructed. Scene reconstruction allows plays of a sporting event, for instance, to be abstracted and shown at a high level. This allows a user to become more familiar with technical aspects of the game. Scene reconstruction may be performed through techniques known to those skilled in the art. For example, objects are already being tracked, and it is possible to determine where the objects are relative to the entire scene. In other words, it is possible to map the objects and particular camera views onto an overall scene model. In step 128, scene reconstruction information is added to the output. It should be noted that an analyst can also review the sporting event and add his or her own analysis of the proper reconstruction. In this manner, an actual scene reconstruction can be compared with an “ideal” construction as determined by an analyst.

In step 130, the camera views, tracking information, statistical information, and scene reconstruction are transmitted. Generally, in analog systems, camera views will be constantly transmitted such that there will be very little delay between when a camera receives its image and when the camera view is transmitted. This means that the object tracking and statistical information may be slightly delayed relative to the camera images. Alternatively, data from the camera views can be held for a short period to ensure that the tracking and statistical information is sent at the same time as the camera images to which they refer.

Transmission of the camera views may also entail converting an analog signal to a digital signal and compressing the digital signal. This is commonly performed, particularly when transmitting over satellite links. This has a benefit in that the time it takes to compress a signal is probably long enough that the tracking and statistical information can be determined.

In step 135, the transmitted camera views, object tracking information, and statistical information is received. Generally, this information is digitally received, such as by a satellite receiver. The satellite receiver may be in the home of a user or could be at a local cable television company. The cable television company could create an analog signal from the received signal or could pass the digital signal to local users. Generally, a digital signal, particularly for the object tracking and statistical information, will be passed to the users, but analog signals are also possible.

In step 140, a user enters his or her preferences. These preferences are usually entered into a set-top box of some kind. The set-top box will generally have a list of possible preferences, and this list can be downloaded from satellite or the local cable television company. The user preferences indicate which object should be tracked, which statistics, if any, should be shown, what tracking events should be enabled or disabled, whether a particular camera view is preferred and, if so, which camera view is preferred, and whether a particular area of the field is preferred and, if so, which area is preferred. The user preferences can be specified by the user for each event or automatically derived by observing user behavior and recorded in a user profile.

The preferences may also contain an order. For example, if a user would like to be shown the home team side of a playing field, there may be times when no camera is directed to that section of the field. In this case, a secondary preference for the user could indicate that the user chooses to see one particular player.

In step 145, it is determined if object tracking is enabled for any object. If so (step 145=YES), the camera view or views containing the object are selected. Generally, the received object tracking information is used to determine which, if any, camera views contain the object. This occurs in step 150. It should be noted that this step could track objects and determine statistical information for the objects. However, this would entail a fairly sophisticated receiver or set-top box, which would have to be replicated many times, as there are many receivers and few transmitters. Consequently, the transmitter is usually a better place at which the object tracking and statistical determinations may be performed.

In step 155, it is determined if the object is contained in one camera view. If the object is not contained in one camera view (step 155=NO), then a voting scheme is used to determine which camera view should be selected (step 160). This could occur, for instance, if no camera views contain the object or if more than one camera view contains the object. In the former case, step 160 will vote to determine which camera view to select. The user preferences could contain preferences for such a situation, and the voting scheme could use these. Alternatively, the voting scheme could determine which camera view is the “closest” to the object or which camera view might contain the object in a future shot. This voting would be performed, e.g., based on the previous trajectory of the object, although this also likely requires some indication as to where the cameras are positioned. For the case of two or more camera views that contain the object, the voting system of step 160 votes to determine which camera view has the best view of the object. Alternatively, the voting system can vote based on which camera view will be closest to the previously selected camera view. In this manner, camera angles will be made to change at a slow pace instead of having a user endure rapid changes.

It should also be noted that steps 145 through 165 may be used to determine which camera view to show if a user selects a portion of a playing field to display. If the portion of the playing field is in more than one camera view or no camera views (step 155=YES), then a voting scheme is used (step 160) to determine which camera view, which does not contain a view of the correct area of the playing field, to display.

If the object is in only one view (step 155=YES) or if the voting step 160 has selected an appropriate view, then the selected view is shown in step 165. Additionally, if object tracking is not enabled (step 145=NO), in step 170 it is determined if a certain view is chosen. If so (step 170=YES), the chosen camera view is displayed in step 165. This allows a user to select one camera view. If a certain view is not chosen (step 170=NO), method 100 proceeds to step 175.

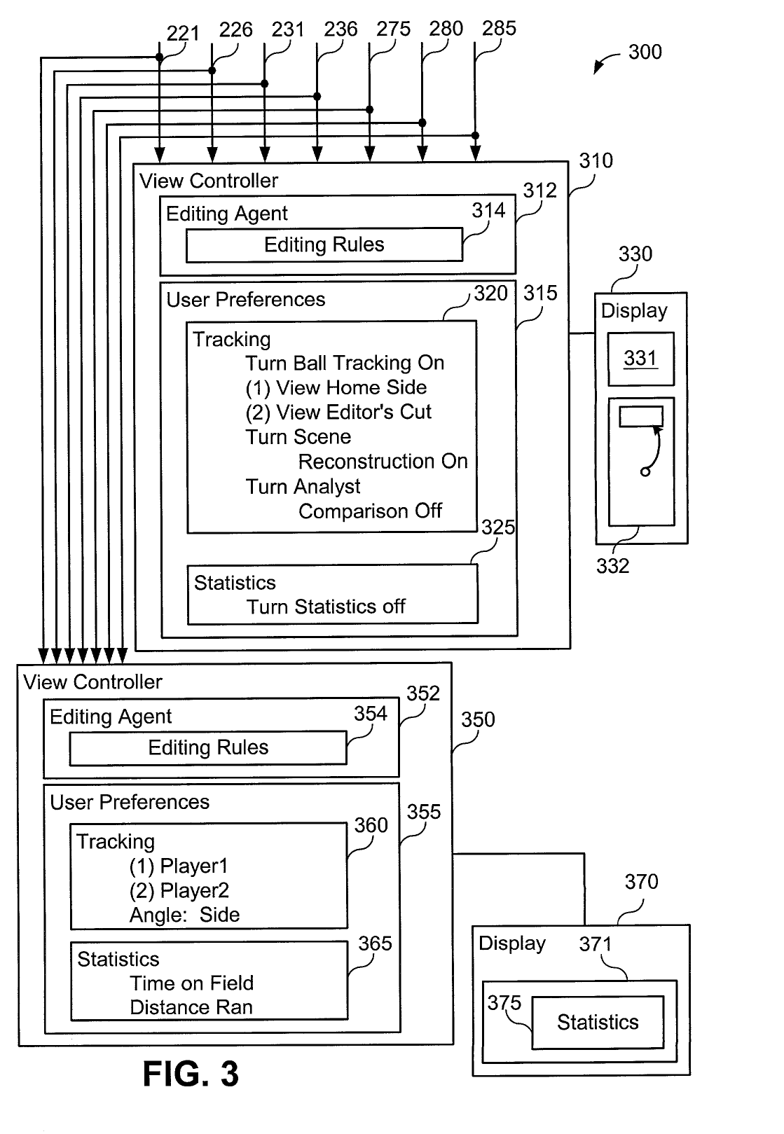

It should be noted that, in step 165, editing may be performed to lessen effects caused by changes between camera views. For example, black or gray frames may be inserted between camera view changes. Other editing rules may be used to make the overall presentation of the program more appealing. This is explained in more detail below in reference to FIG. 3.

In step 175, it is determined if any statistics are chosen to be viewed by the user. If so (step 175=YES), step 180 determines which statistics have been chosen, and for which players they have been chosen. In step 185, the selected statistics are formatted and displayed.

In step 190, it is determined if additional data is selected. Such additional data could include tracking events, such as a “first down” or “world record” line, as previously discussed. If this additional information is selected (step 190=YES), then it is displayed in step 195. Additional data that could be included here is the tracking information itself. For instance, the tracking information could be used to determine paths taken by the players and the ball or other object. This would allow reconstruction of set plays, making it possible to see the offensive and defensive positions and potential poor or good decisions made by the players. This will also allow, with sufficient expertise by an analyst, an overlay of what should have happened to be placed on what actually happened.

Finally, if so desired, the output by the transmitter could also carry the editing commands themselves. For example, in normal broadcasts, an editor tells a central location which camera view should be broadcast. When the editor makes a change from one camera view to another, this change could be recorded. These recordings can be sent as data to receivers. The user can then select whether he or she would like to view the camera views selected by the editor. The editor may have multiple cuts being developed, or there could be multiple editors who have control over their own camera views. A user can then choose to select one of the cuts from a editor. This additional data can be selected in step 140 and acted upon in step 190.

If no additional data is selected (step 190=NO), then the method ends.

Turning now to FIG. 2, a block diagram is shown of a transmitting section 200 of an apparatus for tracking objects in sports programs (or other content) and selecting an appropriate camera view, in accordance with a preferred embodiment of the invention. Transmitting section 200 comprises the following: four cameras 220, 225, 230, and 235 that are viewing a soccer field 205; camera signals 221, 226, 231, and 236; a transmitter 240; an object tracking data stream 275; a statistics data stream 280; and an abstraction data stream 285. A player 210 is on the field 205, and a portion 215 of the field 205 has been selected by a user. Transmitter 240 comprises object tracking system 245 and statistics determination system 260. Object tracking system 245 comprises a number of object tracking entries 250, 255, and abstraction 246. Each object tracking entry 250, 255 comprises an object identification 251, 256, a camera identification 252, 257, a position or positions 253, 258, and a frame location 254, 259. Abstraction 246 comprises a scene reconstruction 247 and an analyst comparison 248. Statistics determination system 260 comprises statistics information 270 for a first player and the following exemplary statistical information: average distance kicked 271, distance ran 272, time on field 237, and shots on goal 274.

Each camera 225, 230, and 235 is shown at one particular time, and each camera has a particular view of the soccer field 205. Cameras 225 and 230 are shooting an area of the field where player 210 currently has the ball. Camera 235 is shooting the opposite end of the field 205.

Camera 220 is an optional camera used to help track objects. This camera is fixed and maintains a constant view of the entire field 205. This view makes it easier to determine locations of objects, as there are possibly times when no camera, other than camera 220, will have a view of an object. For example, a person standing near portion 215 but away from the view of camera 235 will not be in the view of any camera other than camera 220. Additionally, because its location and view are always fixed, tracking objects is easier because all of the objects will be within the view of camera 220.

Cameras 220, 225, 230, and 235 can be digital or analog. Each camera 220, 225, 230, and 235 produces a camera signal 221, 226, 231, and 236, respectively. These signals are submitted to transmitter 240, which uses them to track objects and determine statistics about the objects. If analog, these signals may also be converted to digital. Additionally, they can be compressed by transmitter 240. Object tracking system 245 uses techniques known to those skilled in the art to track objects. Such techniques include face, number and outline recognition and Radio Frequency (RF) tag determination and tracking. The tracking information for objects is packaged and transmitted to receivers.

One exemplary system for packaging the tracking information is shown in FIG. 2. A number of object tracking entries 250, 255 are developed. There is one object tracking entry 250, 255 for each object. Each entry 250, 255 contains an object identification 251, 256 that uniquely identifies the object. Although not shown, a list of objects and their identities will generally be transmitted. Each entry 250, 255 also comprises camera identifications 252, 257. If the object is in multiple camera views, multiple camera identifications may be placed in an entry. Each entry 250, 255 has a position or positions 253, 258 which contain one position, within a video frame, where the object resides. Alternatively, there could be multiple positions so that lines, such as a “first down” line, can be created.

Each entry 250, 255 has a frame location 254, 259. The frame location 254, 259 informs a receiver a frame to which the entry refers. This could also be a time or other indicator. What is important is that a receiver can correlate the entry 250, 255 with a particular section of video from a particular camera.

Statistics determination system 260 determines, using the tracking information created by the object tracking system 245, statistics about the object. Exemplary statistics 270 are shown for a first player. These statistics are average distance kicked 271, distance ran 272, time on field 273, and shots on goal 274. Once an object is tracked, there are many different types of statistics that can be gathered.

Abstraction 246 is a high level view of a scene, and it is created by using object tracking of objects from camera signals 226, 231, and 236 (and potentially camera signal 221), along with an appropriate layout of the entire viewing area. By mapping the objects onto a complete representation of the viewing area, scene reconstruction 247 can be determined. If desired, an analyst comparison 248 may also be created. Analyst comparison 248 is a scene reconstruction, using the complete representation of the viewing area, of an “ideal” scene. This allows, e.g., a user to see how a play in a sporting event should have unfolded, as opposed to how it really did unfold.

Abstraction data stream 285, therefore, contains scene reconstruction information 247 and, possibly, a reconstruction 248 by an analyst. The scene reconstruction information 247 allows movements of the objects to be abstracted onto an entire viewing area. Illustratively, the scene reconstruction information 247 could comprise locations within a viewing area and time information for each object. For example, the information could comprise the following: “At Time1, ObjectA was at LocationA and ObjectB was at LocationB; At Time2, ObjectA and ObjectB were at LocationC.” The locations will usually be relative to the layout of the viewing area, although other locating schemes are possible. The layout and dimensions of the viewing area itself may also be packaged into the abstraction data stream 285, although the layout and dimensions probably would only have to be sent once. All of this information allows an entire scene to be reconstructed. Additionally, an analyst can create an “ideal” scene reconstruction 248, along with comments, that can be added to data stream 285. A user can then compare the “ideal” scene reconstruction 248 versus the actual scene reconstruction 247. It should be noted that abstraction data stream 285 can also contain “start” and “stop” data to allow the beginning of a play, for instance, and the end of a play to be determined.

In the example of FIG. 2, object tracking data is sent out as its own object tracking data stream 275, statistics are transmitted as its own statistics data stream 280, and abstractions are transmitted as their own abstraction data stream 285. However, this is solely an example. They could be combined or even appended to camera signals 221, 226, 231, and 236.

Turning now to FIG. 3, a block diagram is shown of a receiving section 300 of an apparatus for tracking objects in sports programs (or other content) and selecting an appropriate camera view, in accordance with a preferred embodiment of the invention. Receiving section 300 comprises the following: camera signals 221, 226, 231, and 236; an object tracking data stream 275; a statistics data stream 280; an abstraction data stream 285; two view controllers 310, 350; and two displays 330, 370. Both view controllers 310, 350 receive camera signals 221, 226, 231, and 236, object tracking data stream 275, and statistics data stream 280.

The view controllers 310 and 350 determine which view to display on their respective displays 330 and 370. The view controllers 310, 350 use editing agent 312, 352 to determine an appropriate view, and editing agents 312, 352 consult user preferences 315 and 355.

View controller 310 contains editing agent 312 and user preferences 315. The editing agent 312 is optional but beneficial. Editing agent 312 comprises editing rules 314. Editing agent 312 acts like a software version of an editor. Using editing rules 314, the editing agent 312 reduces or prevents jarring transitions between camera views, and helps to maintain the best view in line with user preferences 315. To create an appropriate output on display 330, the editing agent 312 consults editing rules 314 and user preferences 315.

Editing rules are rules that determine when and how camera views should be transferred. For instance, an editing rule could be, “maintain one camera view as long as the camera view contains the object being tracked, unless the object has transitioned into the view of a second camera, then switch to the second camera.” Another rule might be, “when transitioning from a camera at one end of the field to another camera at the other end of the field, choose an intermediate camera for at least three seconds as long as the intermediate camera has a view of the object being tracked. Yet another rule might be, “when a field has both light and dark areas, preferentially select camera views that show the dark area.” Another rule might be, “when a fast-moving object rapidly changes directions, choose a camera view that contains the object and the largest view of the field before changing to a view that has a smaller view of the field.”A final rule might be, “when changing camera views, drop one frame and replace it with a frame that is colored black.”

Thus, the editing agent 312 acts to soften transitions between camera views and to provide a better overall user experience. The editing agent 312 controls the output to the display 330, and the editing agent 312 attempts to perform its duties without overriding any preferences in user preference 315. If a conflict occurs, generally the user preferences 315 will control.

It should be noted that it is possible for a user to have some control over the editing agents 312, 352. For example, a user could direct the editing agents 312, 352 to select the best view of an object, regardless of how poor transitions between cameras will be. As another example, a user might force the editing agents 312, 352 to hold camera views as long as possible. These user preferences may be stored in user preference 315, 355, or may be stored with editing agents 312, 352.

The user preferences 315 contain tracking preferences 320 and statistics preferences 325. In this example, tracking preferences 320 has ball tracking turned on, an ordered list of preferences, and some scene reconstruction preferences. The ordered list contains “(1) view home side” and “(2) view editor's cut.” This means that the home side (portion 215 in FIG. 2) is to be viewed unless there are no cameras that have a view of the home side. From FIG. 2, it can be seen that camera 220 has a view of the entire field 205. However, camera 220 is on the opposite side of the field from portion 205. Consequently, if camera 235 does not have a view of portion 205, the view controller 310 will select the editor's cut. The “editor's cut” is the version made by an editor at the sporting event, and not the “editing agent 312. One of the camera signals 221, 226, 231, and 236 could be dedicated to the editor's cut. Alternatively, the editor's cut could be sent as a series of commands, telling the view controller 310 to change to a particular camera signal at a particular time. In this example, camera 235 (see FIG. 2) has a good view of portion 215, so this camera view is shown on display 330 in area 331. The user preferences 315 has statistics turned off in statistics preferences 325, so no statistics are shown on display 331.

However, the tracking preferences 320 has the preferences “Turn Scene Reconstruction On” and “Turn Analyst Comparison Off.” The “Turn Scene Reconstruction On” preference means that information from abstraction data stream 285 will be used to create scene reconstruction 332 on display 330. In this example, the flight of a ball is reconstructed. Player positions and movements may also be reconstructed. In this example, there is no analyst comparison because the user has turned off this feature.

Editing agent 352 and editing rules 354 are similar to editing agent 312 and editing rules 314. View controller 350 has a different user preferences 355. Tracking user preferences 360 indicates that this user wants to see Player1 and, if Player1 cannot be shown, Player2. In this example, Player1 is player 210 of FIG. 2, so there are three cameras 220, 225, and 230 that have views of player 210. As described in reference to FIG. 1, a voting scheme is used to determine which camera view to actually show. The user has selected an “angle:side” preference, which means that the user would rather have the side of the field shown. Using this preference, the view controller 350 selects camera view 225 and displays this in location 371 on display 370.

This user also has statistics preferences 365. These statistics preferences 365 are “time on the field” and “distance ran.” Since no players are selected in the statistics preferences 365, it is assumed that the two players that are selected in tracking preferences 360 are the players for which statistics are shown. This could easily be changed by the user.

In this example, these two statistics for both players Player1 and Player2 are shown in statistics location 375.

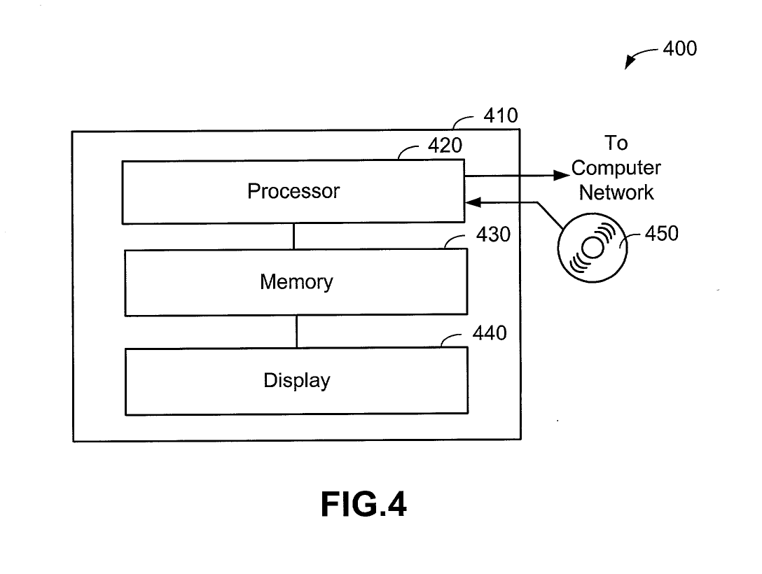

Referring now to FIG. 4, a block diagram is shown of an exemplary system 400 suitable for carrying out embodiments of the present invention. System 400 could be used for some or all of the methods and systems disclosed in FIGS. 1 through 3. System 400 comprises a computer system 410 and a Compact Disk (CD) 450. Computer system 410 comprises a processor 420, a memory 430 and a video display 440.

As is known in the art, the methods and apparatus discussed herein may be distributed as an article of manufacture that itself comprises a computer-readable medium having computer-readable code means embodied thereon. The computer-readable program code means is operable, in conjunction with a computer system such as computer system 410, to carry out all or some of the steps to perform the methods or create the apparatuses discussed herein. The computer-readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk, such as compact disk 450.

Memory 430 configures the processor 420 to implement the methods, steps, and functions disclosed herein. The memory 430 could be distributed or local and the processor 420 could be distributed or singular. The memory 430 could be implemented as an electrical, magnetic or optical memory, or any combination of these or other types of storage devices. Moreover, the term “memory” should be construed broadly enough to encompass any information able to be read from or written to an address in the addressable space accessed by processor 410. With this definition, information on a network is still within memory 430 because the processor 420 can retrieve the information from the network. It should be noted that each distributed processor that makes up processor 420 generally contains its own addressable memory space. It should also be noted that some or all of computer system 410 can be incorporated into an application-specific or general-use integrated circuit.

Video display 440 is any type of video display suitable for interacting with a human user of system 400. Generally, video display 440 is a computer monitor or other similar video display.

It is to be understood that the embodiments and variations shown and described herein are merely illustrative of the principles of this invention and that various modifications may be implemented by those skilled in the art without departing from the scope and spirit of the invention.

What is claimed is:

1. A method for tracking objects in a program and for selecting an appropriate camera view, the method comprising the steps of:
entering one or more user preferences;
selecting one or more camera views, of a plurality of camera views, based on the one or more user preferences; and
displaying the one or more selected camera views.

2. The method of claim 1, wherein the program is a sports program comprising a plurality of objects, wherein the method further comprises the steps of tracking at least one of the plurality of objects, and creating a scene reconstruction comprising a representation of the at least one object and a representation of a playing area.

3. The method of claim 2, wherein the method further comprises the step of creating an analysts scene reconstruction and overlaying the analysts scene reconstruction and the scene reconstruction having the at least one object.

4. The method of claim 1, wherein the step of selecting one or more camera views, of a plurality of camera views, based on the one or more user preferences further comprises the step of selecting the one or more camera views based on one or more editing rules.

5. The method of claim 1, wherein the step of selecting one or more camera views, of a plurality of camera views, based on the one or more user preferences further comprises the step of editing transitions between camera views.

6. The method of claim 1, wherein one of the preferences relates to tracking a particular object of a plurality of objects in the sports program, wherein the one object is in multiple camera views, and wherein the step of selecting further comprises the step of voting in order to select one of the multiple camera views.

7. The method of claim 1, wherein there are a plurality of user preferences, wherein the plurality of user preferences are in an order, wherein a highest preference cannot be met by any camera view, and wherein the step of selecting further comprises the step of selecting a camera view based on a preference other than the highest preference.

8. The method of claim 1, further comprising the steps of transmitting each of the plurality of camera views and receiving each of the plurality of camera views.

9. The method of claim 1, wherein the program is a sports program, wherein one of the user preferences is to show a region of a field, and wherein the step of selecting further comprises the step of selecting, from the plurality of camera views, a camera view that shows the region of the field.

10. The method of claim 1, further comprising the step of tracking, using at least one camera view, at least one object, wherein the step of entering further comprises the step of entering a user preference to track the at least one object, and wherein the step of selecting further comprises selecting a camera view that shows the at least one object.

11. The method of claim 10, further comprising the steps of determining tracking information for the at least one object, transmitting the tracking information for the at least one object, and receiving the tracking information for the at least one object.

12. The method of claim 1, further comprising the step of tracking, using at least one camera view, at least one object, and the step of determining statistical information by using the tracking of the at least one object, wherein the statistical information comprises at least one statistic, wherein the step of entering a user preference further comprises entering a preference to view the at least one statistic, and wherein the step of displaying further comprises the step of displaying the at least one statistic.

13. The method of claim 1, wherein the step of entering further comprises entering a preference for one camera view, and wherein the step of selecting comprises selecting the one camera view.

14. The method of claim 1, wherein the program is a sports program, wherein the sports program comprises a plurality of objects, wherein the method further comprises the steps of tracking each of the objects, determining tracking information for each of the objects, transmitting the tracking information for each of the objects, and receiving the tracking information for each of the objects, wherein the step of entering further comprises the step of entering a preference to be shown one or more of the objects, and wherein the step of selecting further comprises the step of selecting the one or more objects having a preference for being shown.

15. The method of claim 14, wherein the sports program comprises a plurality of objects, and wherein at least one of the objects has a radio frequency tag attached to it.

16. The method of claim 1, wherein the program is a sports program, wherein the sports program comprises a plurality of objects, and wherein at least one of the objects has a radio frequency tag attached to it.

17. A system comprising:
a memory that stores computer-readable code; and
a processor operatively coupled to the memory, the processor configured to implement the computer-readable code, the computer-readable code configured to:
enter one or more user preferences;
select one or more camera views, of a plurality of camera views, based on the one or more user preferences; and
display the one or more selected camera views.

18. An article of manufacture comprising:
a computer-readable medium having computer-readable code means embodied thereon, said computer-readable program code means comprising:
a step to enter one or more user preferences;
a step to select one or more camera views, of a plurality of camera views, based on the one or more user preferences; and
a step to display the one or more selected camera views.

19. A system comprising:
means for entering one or more user preferences;
means for selecting one or more camera views, of a plurality of camera views, based on the one or more user preferences; and
means for displaying the one or more selected camera views.

20. A method for selecting an appropriate camera view on a receiver, the method comprising the steps of:
entering one or more user preferences;
receiving a plurality of camera views;
selecting one or more camera views, of the plurality of camera views, based on the one or more user preferences; and
displaying the one or more selected camera views.

21. The method of claim 20, wherein the step of selecting one or more camera views, of the plurality of camera views, based on the one or more user preferences further comprises the step of editing transitions between camera views.

22. A system for selecting an appropriate camera view on a receiver, the system comprising:
a memory that stores computer-readable code; and
a processor operatively coupled to the memory, the processor configured to implement the computer-readable code, the computer-readable code configured to:
enter one or more user preferences;
receive a plurality of camera views;
select one or more camera views, of the plurality of camera views, based on the one or more user preferences; and
display the one or more selected camera views.
